(19) United States
(12) Patent Application Publication
(10) Pub. No.: US 2026/0078037 A1
(43) Pub. Date: Mar. 19, 2026

(54) WATER TREATMENT SYSTEM AND WATER TREATMENT METHOD

(71) Applicant: ORGANO CORPORATION, Tokyo (JP)

(72) Inventors: Yusuke TAKAHASHI, Tokyo (JP); Yuki NAKAMURA, Tokyo (JP); Naoya YOSHINAGA, Tokyo (JP); Kazushige TAKAHASHI, Tokyo (JP)

(73) Assignee: ORGANO CORPORATION, Tokyo (JP)

(21) Appl. No.: 19/108,520

(22) PCT Filed: Jul. 12, 2023
(86) PCT No.: PCT/JP2023/025729

§ 371 Date: Mar. 4, 2025

(30) Foreign Application Priority Data
Sep. 16, 2022 (JP) 2022-147932

(51) Int. Cl. C02F 9/00; C02F 1/00; C02F 1/20; C02F 1/32; C02F 1/72; C02F 101/30

(52) U.S. Cl. CPC C02F 9/00; C02F 1/008; C02F 1/20; C02F 1/325; C02F 1/722; C02F 2101/30; C02F 2201/326; C02F 2209/20; C02F 2209/22; C02F 2209/40; C02F 2301/08

(57) ABSTRACT

A water treatment system including: a water treatment facility equipped with a plurality of water treatment devices to treat treated water, a water treatment management device to which is supplied treated water that flows to any of the water treatment devices, and a controller that controls operating conditions of the water treatment devices. The water treatment management device includes a TOC measurement unit that measures the TOC concentration of the water flowing through the water line of the water treatment management device and a specific organics measurement unit that measures the specific organics concentration in the water flows through the water line of the water treatment management device. The controller controls operating conditions of the water treatment devices based on the TOC concentration measured by the TOC measurement unit and the specific organics concentration measured by the specific organics measurement unit.

### TECHNICAL FIELD

This invention relates to a water treatment system and a water treatment method.

### BACKGROUND OF ART

In water treatment systems such as ultrapure water production systems that generate ultrapure water from raw water, close attention must be paid to the quality of raw water supplied to the water treatment system. For example, in ultrapure water production systems, reverse osmosis membrane (RO) treatment and ultraviolet (UV) oxidation treatment are used to remove organic substances (TOC: Total Organic Carbon) contained in raw water. However, there are some components of the organic matter to be removed that are easily removed by these treatments and others that are not. Until now, tap water, indigenous water, and industrial water have been used as raw water supplied to ultrapure water production systems. In recent years, to make effective use of water resources, regenerated water, which is recycled by treating and reusing water that is generated in daily life such as sewage, and recovered water, which is recycled by treating for example factory wastewater, are increasingly being used as raw water. The quality of regenerated and recovered water tends to be inconsistent compared to that of industrial water. Regenerated or recovered water may also contain unexpected organic matter. Hard-to-remove organic matter that is mixed in the raw water may affect the quality of the treated water supplied from the outlet of the ultrapure water production system. Therefore, monitoring the quality of raw water in ultrapure water production systems and properly controlling the operation of ultrapure water production systems according to water quality are becoming increasingly important.

In addition, various methods of decomposing and removing trace amounts of organic matter contained in pure water have been studied in recent years as the high demand for pure water quality becomes more apparent. A typical example of such a method is the use of a UV oxidation process to decompose and remove organic matter. In this context, a technique is being considered for accelerating oxidation of TOC in treated water by adding a sulfur compound containing peroxide groups to the water to be treated and subsequently irradiating the water with ultraviolet light. Patent Document 1 describes a technology for controlling the irradiation amount of the UV irradiator in the main system based on the TOC value of treated water of an ultrapure water production subsystem installed separately from the main system. In addition, Patent Document 2 describes a technology in which sulfur compounds are added to treated water and treated with ultraviolet light.

### PRIOR ART DOCUMENTS

### Patent Documents

Patent Document 1: JP 2016-107249A
Patent Document 2: JP 2008-229417A

### SUMMARY OF THE INVENTION

### Problem to be Solved by the Invention

In the technology described in Patent Document 1, the UV oxidation device of the main system is assumed to be a low-pressure UV oxidation device. This method is effective when only TOC components that are easily removed by low-pressure UV are detected. Treated water in an ultrapure water production subsystem may contain persistent TOCs that are difficult to remove with an RO or low-pressure UV oxidation device. In such cases, if the UV irradiation dose in the main system is controlled based on the TOC value of the treated water of the ultrapure water production subsystem, the dose may be an inappropriate (e.g., excessive) amount. TOC components (e.g., urea) that are difficult to remove even with excessive irradiation in a low-pressure UV oxidation device will contaminate the treated water, resulting in a decline in water quality. In addition, Patent Document 2 makes no mention of controlling the irradiation dose or persulfate concentration. When there are fluctuations in the TOC of the treated water in the method described in Patent Document 2, the amount of irradiation or addition to TOC may be excessive or insufficient and consistent treatment is therefore difficult. In addition, excessive irradiation and additives lead to increased power consumption, resulting in higher operating costs.

Thus, the above-described technology has the problem of not being able to realize consistent and efficient TOC removal.

The purpose of the present invention is to provide a water treatment system and a water treatment method that can realize consistent and efficient TOC removal.

### Means for Solving the Problem

A water treatment system of the present invention is the water treatment system, comprising:
a water treatment facility equipped with a plurality of water treatment devices to treat treated water;
a water treatment management device to which is supplied the treated water that is supplied to any of the plurality of water treatment devices; and
a controller that controls operating conditions of the water treatment devices, wherein
the water treatment management device comprises:
a first measurement unit that measures TOC concentration of water that is being passed through a water flow line of the water treatment management device; and
a second measurement unit that measures concentration of specific organic matter in the water that is being passed through the water flow line of the water treatment management device, wherein
the controller controls operating conditions of the water treatment devices based on the TOC concentration measured by the first measurement unit and the concentration of specific organic matter measured by the second measurement unit.

Also, a water treatment system of the present invention is the water treatment system, comprising:
a water treatment facility equipped with a plurality of water treatment devices to treat treated water;
a water treatment management device to which is supplied the treated water that is supplied to any of the plurality of the water treatment devices;
an oxidizer addition means that adds an oxidizer to the treated water; and
a controller that controls operating conditions of the water treatment devices, wherein
the water treatment management device comprises:
a measurement unit that measures TOC concentration of the water that is being passed through a water flow line of the water treatment management device, wherein
the controller, based on the TOC concentration measured by the measurement unit, controls at least one of the amount of oxidizer added by the oxidizer addition means and the irradiation dose applied to the treated water to which the oxidizer addition means has added oxidizer from, of the plurality of water treatment devices, the UV irradiator.

Also, a water treatment method of the present invention is the water treatment method, comprising:
measuring the TOC concentration of water being passed through a water flow line of a water treatment management device to which is supplied treated water that is supplied to any of a plurality of water treatment devices in a water treatment facility that uses the plurality of water treatment devices to treat the treated water;
measuring concentration of specific organic matter in the water that is being passed through the water flow line of the water treatment management device; and
controlling operating conditions of the water treatment devices based on the measured TOC concentration and the measured concentration of the specific organic matter.

### Advantageous Effects of the Invention

In this invention, consistent and efficient removal of TOC can be achieved.

### BRIEF DESCRIPTION OF THE DRAWINGS

FIG. 1 is a diagram showing a first embodiment of a water treatment system of the present invention.

FIG. 2 is a flowchart for explaining an example of processing in the controller shown in FIG. 1.

FIG. 3 is a diagram showing a second embodiment of a water treatment system of the present invention.

FIG. 4 is a flowchart for explaining an example of processing in the controller shown in FIG. 3.

FIG. 5 is a diagram showing a third embodiment of a water treatment system of the present invention.

FIG. 6 is a flowchart for explaining an example of processing in the controller shown in FIG. 5.

FIG. 7 is a diagram showing a fourth embodiment of a water treatment system of the present invention.

FIG. 8 is a flowchart for explaining an example of processing in the controller shown in FIG. 7.

FIG. 9 is a diagram showing a fifth embodiment of a water treatment system of the present invention.

FIG. 10 is a flowchart for explaining an example of processing in the controller shown in FIG. 9.

FIG. 11 is a diagram showing a sixth embodiment of a water treatment system of the present invention.

FIG. 12 is a flowchart for explaining an example of processing in the controller shown in FIG. 11.

FIG. 13 is a diagram showing the configuration of Example 1-1 of the water treatment system of the present invention.

FIG. 14 is a diagram showing the configuration of Comparative Example 1-1 that is compared with Example 1-1.

FIG. 15 is a diagram showing the configuration of Example 1-2 of the water treatment system of the present invention.

FIG. 16 is a diagram showing the configuration of Comparative Example 1-2 that is compared with Example 1-2.

FIG. 17 is a diagram showing the configuration of Example 2-1 of the water treatment system of the present invention.

FIG. 18 is a diagram showing the configuration of Example 2-2 of the water treatment system of the present invention.

FIG. 19 is a diagram showing the configuration of Example 3-1 of the water treatment system of the present invention.

FIG. 20 is a diagram showing the configuration of Example 3-2 of the water treatment system of the present invention.

FIG. 21 is a diagram showing the configuration of Example 4-1 of the water treatment system of the present invention.

FIG. 22 is a diagram showing the configuration of Example 4-2 of the water treatment system of the present invention.

### DESCRIPTION OF THE EMBODIMENTS

Embodiments of the invention are next described with reference to the drawings.

### First Embodiment

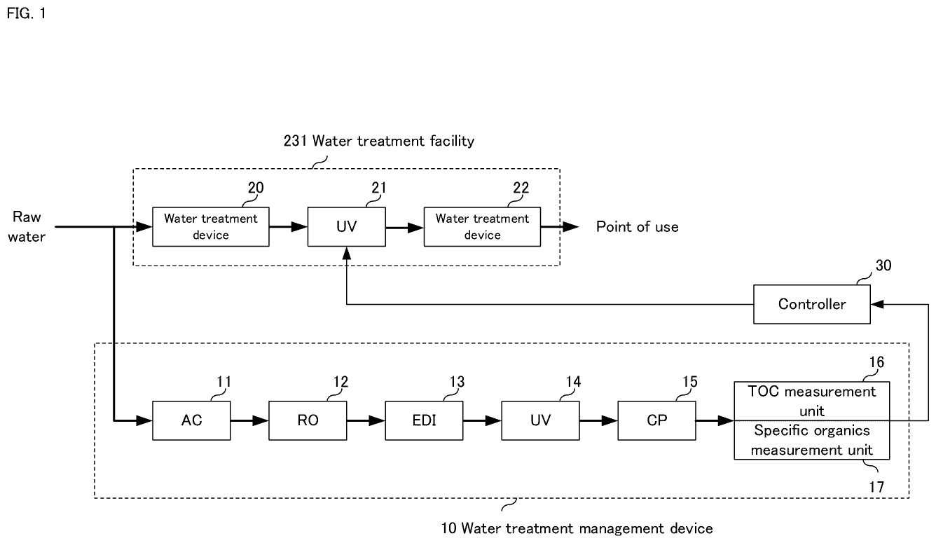

FIG. 1 is a diagram showing the first embodiment of a water treatment system of the present invention. As shown in FIG. 1, the water treatment system in this embodiment includes water treatment facility 231 equipped with water treatment device 20 that has the function of removing urea, UV 21 that is a UV irradiator, and water treatment device 22. Water treatment devices 20 and 22 are composed of one or more devices (unitary devices) for treating the target liquid and include, for example, a filtration device, activated carbon, a deionizer device, a reverse osmosis membrane device, a degasser, and a UV irradiator. For example, water treatment device 20 has a filtration device, activated carbon, a deionizer, and a reverse osmosis membrane device, while water treatment device 22 has a deionizer, a degasser, and a membrane treatment device. Raw water, which is treated water, is supplied to water treatment facility 231 (specifically, water treatment device 20). The supplied raw water is sequentially treated in water treatment device 20, UV 21, and water treatment device 22. This process produces water of a predetermined quality (e.g., pure water). The produced water is supplied from water treatment device 22 to, for example, a point of use or another water treatment facility. In the example shown in FIG. 1, a plurality of water treatment devices that make up water treatment facility 231 are arranged together in series along a water line for the treated water. Some or all of the multiple water treatment devices may also be arranged in parallel with each other. This arrangement also applies in the other embodiments described below. The water treatment system in this embodiment includes water treatment management device 10 to which is supplied at least a part of the treated water that is supplied to water treatment facility 231. Water treatment management device 10 includes AC 11 that is activated carbon, RO 12 that is a reverse osmosis membrane device, EDI 113 that is an electro-regenerative pure water device, UV 14 that is a UV irradiator, CP 15 that is a device filled with an ion exchange resin, TOC measurement unit 16, and specific organics measurement unit 17. In this embodiment, AC 11, RO 12, EDI 13, UV 14, and CP 15 are arranged in series along the treated water flow line. At least a portion of the treated water to be supplied to water treatment facility 231 is caused to flow in turn to AC 11, RO 12, EDI 13, UV 14, and CP 15. The water treatment system in this embodiment further includes controller 30.

Water treatment management device 10 is equipped with water treatment devices that perform unit operations to remove TOC components, these devices including, for example, AC 11, RO 12, UV 14, and ion exchange resin-filled devices, as shown in FIG. 1. Water treatment management device 10 need not have a configuration equivalent to that of main water treatment facility 231. Water treatment management device 10 preferably is of a simplified configuration for quickly detecting TOC contained in the treated water and need not be equivalent to main water treatment facility 231. The ion exchange resin-filled device can be EDI 13 as shown in FIG. 1. CP 15 can also be EDI 13. No restrictions apply to the order in which water flows through the water treatment devices in water treatment management device 10, but considering the treatment efficiency of UV irradiation and the life of ion exchange resin, the water flow should be in the order of activated carbon, RO, EDI, UV, and ion exchange resin-filled device. Water treatment management device 10 may be equipped with a degasser device such as a degassing membrane to improve treatment performance. AC 11, RO 12, EDI 13, UV 14, and CP 15 may each be multi-staged. These points also apply in the second through sixth embodiments described below.

TOC measurement unit 16 is the first measurement unit (TOC meter) that measures the TOC concentration of the water being passed through the water flow line of water treatment management device 10. TOC measurement unit 16 outputs the measured TOC concentration values to controller 30. TOC measurement unit 16 may measure the TOC concentration of water treated by other water treatment devices as well as water that has passed through CP 15.

Specific organics measurement unit 17 is a second measurement unit that measures the concentration of organic matter using indicators other than the TOC measured by TOC measurement unit 16. The measurement point at which specific organics measurement unit 17 measures organic matter concentration may be the same position at which TOC measurement unit 16 measures the TOC concentration or may be a different position. For example, if TOC measurement unit 16 measures the TOC concentration of water treated by any of the water treatment devices in water treatment management device 10 and not just CP 15, specific organics measurement unit 17 may measure the organic matter concentration using indicators other than the TOC for the water treated by that water treatment device. Or, for example, if TOC measurement unit 16 measures the TOC concentration at a measurement point that precedes RO 12, specific organics measurement unit 17 may, in consideration of the rejection rate of specific organics at RO 12, estimate the concentration of specific organics in the treated water of CP 15. Or, for example, if TOC measurement unit 16 measures the TOC concentration of the treated water in CP 15 and specific organics measurement unit 17 measures the specific organics concentration at a measurement point that precedes AC 11 or that precedes RO 12, specific organics measurement unit 17 may, in consideration of the rejection rate of specific organics at RO 12, estimate the concentration of specific organics in the treated water of CP 15. Specific organics measurement unit 17 can be, for example, a urea meter that measures the concentration of urea. Specific organics measurement unit 17 outputs the measured organic matter concentration values to controller 30. When estimating the concentration of specific organics in the treated water of CP 15, specific organics measurement unit 17 outputs the estimated values to controller 30 as measurement values.

Controller 30 controls the operating conditions of the water treatment devices that constitute water treatment facility 231 based on the TOC concentration value (TOC value) output from TOC measurement unit 16 and the specific organics concentration value output from specific organics measurement unit 17. In this embodiment, controller 30 controls the UV irradiation dose irradiated by UV 21. Here, the UV irradiation dose controlled by controller 30 is the irradiation power per unit flow rate. For example, controller 30 changes (converts) the specific organics concentration value output from specific organics measurement unit 17 to a TOC value. This conversion is performed using the ratio of the atomic weight of carbon in the organic molecules to the molecular weight of the organic (e.g., urea). Controller 30 may calculate the UV irradiation dose irradiated by UV 21 based on the difference or ratio (ratio of the second TOC value to the first TOC value; this value being used hereinbelow) between the TOC value output from TOC measurement unit 16 (the first TOC value) and the TOC value converted from the organic concentration value output from specific organics measurement unit 17 (the second TOC value). When calculating the UV irradiation dose, controller 30 may use a predetermined calculation formula or correspondence to calculate the UV irradiation dose based on the difference or ratio between the first TOC value and the second TOC value. When calculating the UV irradiation dose, controller 30 may compare the difference or ratio between the first TOC value and the second TOC value with a precalculated threshold value (which may be one or more values) based on the quality (for example, the TOC value or the concentration of dissolved oxygen) of the water supplied from water treatment device 22 to the point of use at that time. As the UV irradiation dose, controller 30 controls at least one of the following: the number of UV 21 lamps that are turned on, the treatment flow rate, and adjustment of the lamps. Alternatively, controller 30 may control the amount of UV irradiation irradiated by the UVs provided in water treatment devices 20 and 22. Controller 30 may also start or stop UV 21 operation based on the difference or ratio between the first and second TOC values. For example, controller 30 may stop UV 21 operation if the difference is less than a threshold value and may start UV 21 operation if the difference is equal to or greater than the threshold value. A reverse osmosis membrane device may be installed in a water treatment device that constitutes water treatment facility 231, and controller 30 may control factors such as the recovery rate or the water temperature of the reverse osmosis membrane device based on the value of the TOC concentration (TOC value) output from TOC measurement unit 16 and the value of organic matter concentration output from specific organics measurement unit 17.

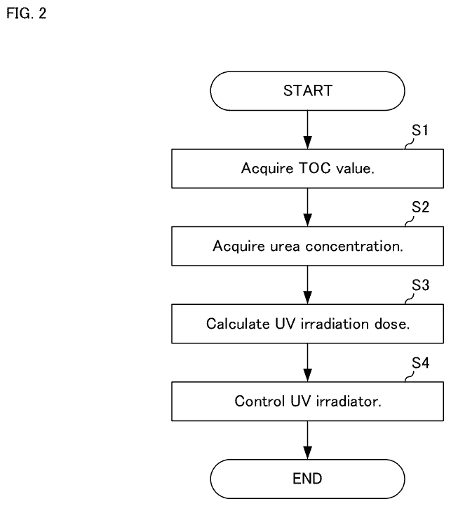

The processing in controller 30 shown in FIG. 1 is next described. FIG. 2 is a flowchart for explaining an example of the processing in controller 30 shown in FIG. 1. The following explanation regards a case in which specific organics measurement unit 17 measures the concentration of urea.

First, controller 30 acquires the TOC value measured by TOC measurement unit 16 (Step S1). Controller 30 also acquires the value of the concentration of urea measured by specific organics measurement unit 17 (Step S2). Controller 30 converts the acquired urea concentration values to TOC values. Controller 30 next calculates the UV irradiation dose based on the acquired TOC value and the TOC value converted from the urea concentration (Step S3). Controller 30 then controls UV 21 to irradiate the calculated UV dose (Step S4).

Thus, in this embodiment, water treatment management device 10 is provided through which flows (that is supplied with) at least a part of the treated water supplied to water treatment facility 231 and that includes a measurement instrument that measures the TOC value and the concentration of specific organics in the water that passes through the water line of water treatment management device 10. Controller 30 controls the amount of UV irradiation of the UV irradiator provided in water treatment facility 231 based on the measured TOC values and specific organics concentrations. Specific organics include, for example, urea, which is difficult to remove by reverse osmosis or by UV irradiation. Urea is commonly treated with bromide and hypochlorous acid, but its relatively long treatment time complicates installation of a urea treatment device in a water treatment management device. Therefore, TOC can be efficiently removed by controlling the amount of UV irradiation irradiated by the UV irradiator based on measurement values that take into account urea, which is difficult to remove by a water treatment management device.

### Second Embodiment

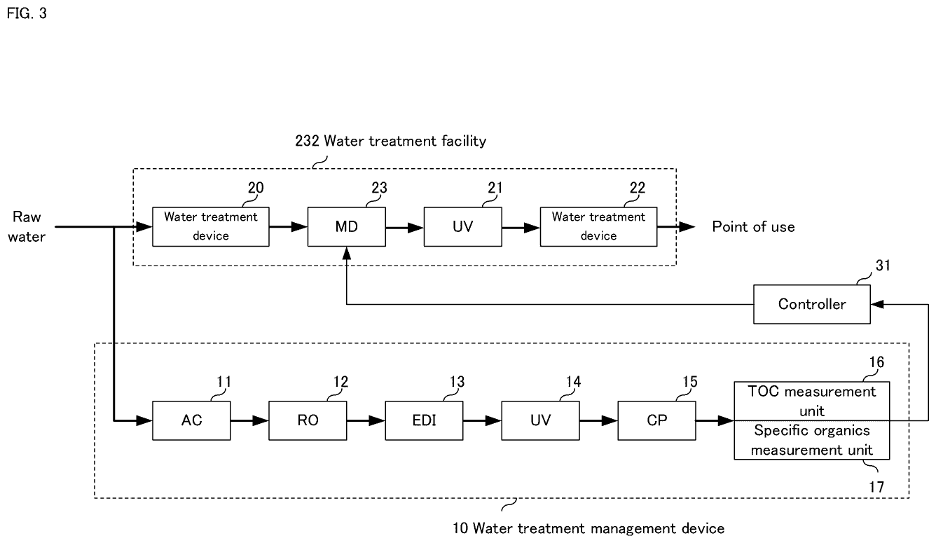

FIG. 3 is a diagram showing the second embodiment of a water treatment system of the present invention. As shown in FIG. 3, the water treatment system in this embodiment includes water treatment facility 232 equipped with water treatment device 20, MD 23 that is a degasser, UV 21 that is a UV irradiator, and water treatment device 22. Raw water, which is treated water, is supplied to water treatment facility 232 (specifically, water treatment device 20). The supplied raw water is sequentially treated in water treatment device 20, MD 23, UV 21, and water treatment device 22. This process produces water of a predetermined quality (e.g., pure water). The produced water is supplied from water treatment device 22 to, for example, a point of use or another water treatment facility. The water treatment system in this embodiment also includes water treatment management device 10 that is supplied with at least a part of the treated water supplied to water treatment facility 232. Water treatment management device 10 is the same as the device in the first embodiment. The water treatment system in this embodiment further includes controller 31.

Controller 31 controls the operating conditions of the water treatment devices that make up water treatment facility 232 based on the TOC concentration value (TOC value) output from TOC measurement unit 16 and the specific organics concentration value output from specific organics measurement unit 17. In this embodiment, controller 31 controls MD 23 to control the dissolved oxygen concentration of the treated water in UV 21. Based on the values measured in water treatment management device 10, controller 31 can set the dissolved oxygen concentration of the treated water in UV 21 of water treatment facility 232 so that the value of the dissolved oxygen meter in water treatment facility 232 is a set value. For example, a dissolved oxygen meter can be installed between MD 23 and UV 21. Examples of MD 23 include vacuum degassers, membrane degassers, and nitrogen degassers. Other degassers can be used to remove oxygen by adding hydrogen and then using a Pd catalyst to cause the oxygen to react with hydrogen to form water. When a vacuum degasser is used as MD 23, controller 31 controls the dissolved oxygen concentration by using a vacuum pump or similar device to adjust the vacuum level. At this time, controller 31 can effect control using an inverter. For example, controller 31 changes (converts) the value of the concentration of organic matter that is output from specific organics measurement unit 17 to a TOC value. This conversion is performed using the ratio of the atomic weight of the carbon in the organic molecules to the molecular weight of the organic (e.g., urea). Controller 31 may calculate the concentration of dissolved oxygen in the treated water in UV 21 that is controlled by MD 23 based on the difference or ratio between the TOC value output from TOC measurement unit 16 and the TOC value that was converted from the organic concentration value output from specific organics measurement unit 17. When calculating the concentration of dissolved oxygen, controller 31 may use a prescribed calculation formula or correspondence to calculate the dissolved oxygen concentration based on the difference or ratio between the TOC value that was output from TOC measurement unit 16 and the TOC value that was converted from the value of the organic matter concentration that was output from specific organics measurement unit 17. When calculating the concentration of dissolved oxygen, controller 31 may use a comparison of the difference or ratio of a TOC value that was output from TOC measurement unit 16 and a TOC value that was converted from the value of the concentration of organics that was output from specific organics measurement unit 17 with a threshold value (one or more values being possible) calculated in advance based on the water quality (for example, the TOC value or dissolved oxygen concentration) of water that was supplied from water treatment device 22 to a point of use at that time. Controller 31 may also start or stop the operation of MD 23 based on the difference or ratio between the TOC value that is output from TOC measurement unit 16 and the TOC value that was converted from the organic concentration value output from specific organics measurement unit 17. For example, controller 31 may stop the operation of MD 23 if the difference is less than a threshold value (one or more values being possible) and may start operation of MD 23 if the difference is equal to or greater than the threshold value. Controller 31 may calculate the amount of UV irradiation irradiated by UV 21 and the concentration of dissolved oxygen in the treated water of UV 21 based on the difference or ratio between the TOC value that is output from TOC measurement unit 16 and the TOC value that was converted from the organic concentration value output from specific organics measurement unit 17. In this case, controller 31 controls UV 21 to irradiate a UV irradiation dose that was calculated and controls MD 23 such that the concentration of dissolved oxygen in the treated water is equal to the dissolved oxygen concentration that was calculated. Controller 31 may also control the combination of UV 21 operation and MD 23 operation to acquire the calculated UV irradiation dose or calculated dissolved oxygen concentration. Whether controller 31 gives priority to controlling the UV irradiation dose or the concentration of dissolved oxygen may be determined by taking into account not only the treatment performance but the operating costs and the load upon water treatment devices that follow the device.

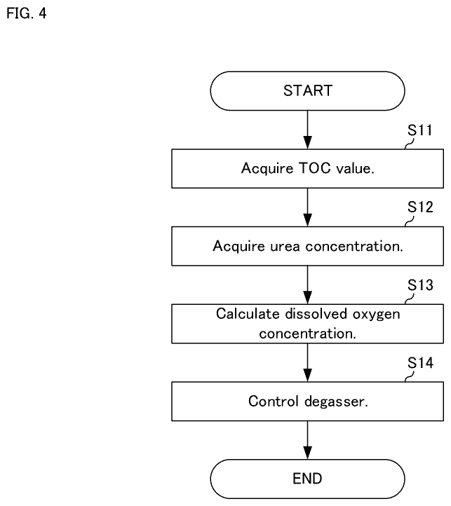

The process in controller 31 shown in FIG. 3 is next described. FIG. 4 is a flowchart for explaining an example of processing in controller 31 shown in FIG. 3. The following explanation regards a case in which specific organics measurement unit 17 measures the concentration of urea.

First, controller 31 acquires the TOC value measured by TOC measurement unit 16 (Step S11). Controller 31 also acquires the value of the urea concentration measured by specific organics measurement unit 17 (Step S12). Controller 31 then converts the value of the acquired urea concentration into a TOC value. Controller 31 next calculates the concentration of the dissolved oxygen based on the acquired TOC value and the TOC value that was converted from the urea concentration (Step S13). Controller 31 then controls MD 23 so that the dissolved oxygen concentration of the treated water becomes the calculated dissolved oxygen concentration (Step S14).

Thus, in this embodiment, water treatment management device 10 is provided that allows passage of (is supplied with) at least a part of the treated water supplied to water treatment facility 232, and measurement instruments measure the TOC value and the concentration of specific organics in the water that passes through the water line of water treatment management device 10. Controller 31 controls the degasser provided in water treatment facility 232 based on the measured TOC value and specific organics concentration. TOC can thus be efficiently removed by controlling the concentration of dissolved oxygen based on measurement values that take into account urea, which is difficult to remove by water treatment management devices.

### Third Embodiment

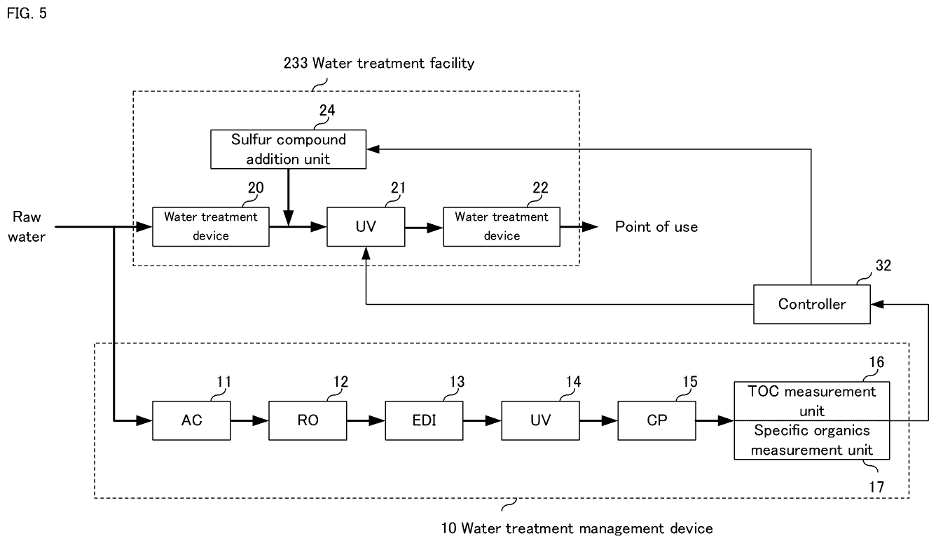

FIG. 5 is a diagram showing the third embodiment of a water treatment system of the present invention. As shown in FIG. 5, the water treatment system in this embodiment includes water treatment facility 233 equipped with water treatment device 20, UV 21 that is a UV irradiator, and water treatment device 22. Raw water, which is treated water, is supplied to water treatment facility 233 (specifically, water treatment device 20). The supplied raw water is sequentially treated in water treatment device 20, UV 21, and water treatment device 22. This process produces water of a predetermined quality (e.g., pure water). The produced water is supplied from water treatment device 22 to, for example, a point of use or another water treatment facility. The water treatment system in this embodiment also includes water treatment management device 10 that is supplied with at least a part of the treated water directed to water treatment facility 233. Water treatment management device 10 is the same as in the first embodiment. The water treatment system in this embodiment further includes controller 32 and sulfur compound addition unit 24, which is an oxidizer addition means. Sulfur compound addition unit 24 may also be included in water treatment facility 233.

Sulfur compound addition unit 24 adds oxidizer to the treated water that is to pass through UV 21 based on the control of controller 32. The oxidizer added by sulfur compound addition unit 24 can be a common oxidizer such as hydrogen peroxide, halogen oxoacids, permanganates, or sulfur compounds containing peroxide groups. In terms of removal performance, the oxidizer added by sulfur compound addition unit 24 is preferably a sulfur compound containing a peroxide group. Sulfur compounds containing peroxide groups include, for example, ammonium peroxodisulfate, sodium peroxodisulfate, and potassium peroxodisulfate. These sulfur compounds are used alone or in combination. UV 21 in this embodiment is a medium-pressure UV irradiator having internal pressure within a predetermined pressure range (higher than a first pressure and lower than a second pressure) or a high-pressure UV irradiator having internal pressure higher than the predetermined pressure (the second pressure). Treated water to which an oxidizer has been added from sulfur compound addition unit 24 is irradiated with UV light by UV 21. UV 21 can be a low-pressure UV irradiator having internal pressure that is lower than the predetermined pressure (the first pressure). A medium-pressure UV irradiator having high irradiation power per UV lamp or a high-pressure UV irradiator is preferably used as UV 21 to make the device more compact. A reduction means may be provided following UV 21.

Controller 32 controls the operating conditions of the water treatment devices that constitute water treatment facility 233 based on the TOC concentration value (TOC value) output from TOC measurement unit 16 and the specific organics concentration value output from specific organics measurement unit 17. In this embodiment, controller 32 controls the amount of oxidizer added by sulfur compound addition unit 24 whereby controller 32 can control the concentration of the oxidizer in the treated water in UV 21 (the same applies in the following description). For example, controller 32 changes (converts) the value of the concentration of organic matter that is output from specific organics measurement unit 17 to a TOC value. This conversion is performed using the ratio of the atomic weight of the carbon in the organic molecules to the molecular weight of the organic (e.g., urea). Controller 32 may calculate the amount of oxidizer to be added from sulfur compound addition unit 24 based on the difference or ratio between the TOC value that is output from TOC measurement unit 16 and the TOC value that was converted from the organic concentration value output from specific organics measurement unit 17. When calculating the amount of oxidizer to be added, controller 32 may use a prescribed calculation formula or correspondence to calculate the amount of added oxidizer based on the difference or ratio between the TOC value that is output from TOC measurement unit 16 and the TOC value that was converted from the organic concentration value output from specific organics measurement unit 17. In addition, when calculating the amount of oxidizer to be added, controller 32 may use a comparison of the difference or ratio of the TOC value that was output from TOC measurement unit 16 and the TOC value that was converted from the value of the organic concentration that was output from specific organics measurement unit 17 with a threshold value (one or more threshold values being possible) that was calculated in advance based on the quality of water (for example, a TOC value or dissolved oxygen concentration) that is supplied to a point of use from water treatment device 22 at that time. Controller 32 may calculate the amount of UV irradiation irradiated by UV 21 and the amount of oxidizer added by sulfur compound addition unit 24 based on the difference or ratio between the TOC value output from TOC measurement unit 16 and the TOC value that was converted from the organic concentration value output from specific organics measurement unit 17. In this case, controller 32 effects control such that UV 21 emits the calculated amount of UV irradiation and sulfur compound addition unit 24 adds the calculated concentration of oxidizer. Controller 32 may also start or stop the operation of UV 21 and the addition of oxidizer from sulfur compound addition unit 24 based on the difference or ratio between the TOC value output from TOC measurement unit 16 and the TOC value that was converted from the organic concentration value output from specific organics measurement unit 17. For example, controller 32 may stop the operation of UV 21 and the addition of oxidizer from sulfur compound addition unit 24 if the difference is less than a threshold value and may start the operation of UV 21 and the addition of oxidizer from sulfur compound addition unit 24 if the difference is equal to or greater than the threshold value.

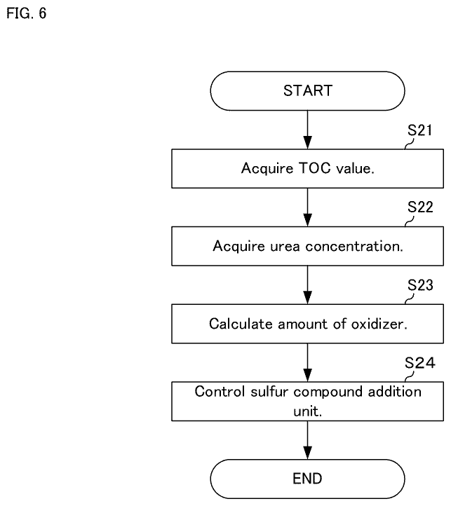

The processing in controller 32 shown in FIG. 5 is next described. FIG. 6 is a flowchart for explaining an example of processing in controller 32 shown in FIG. 5. The following explanation regards a case in which specific organics measurement unit 17 measures the concentration of urea.

First, controller 32 acquires the TOC value measured by TOC measurement unit 16 (Step S21). Controller 32 also acquires the value of the urea concentration measured by specific organics measurement unit 17 (Step S22). Controller 32 converts the acquired urea concentration value to a TOC value. Controller 32 next calculates the amount of oxidizer to be added by sulfur compound addition unit 24 based on the acquired TOC value and the TOC value that was converted from the urea concentration (Step S23). Controller 32 then controls sulfur compound addition unit 24 such that the calculated concentration of oxidizer is added (Step S24).

Thus, this embodiment is provided with water treatment management device 10 that allows passage of (is supplied with) at least a part of the treated water directed to water treatment facility 233, and measurement instruments measure the TOC value and the concentration of specific organics in the water that passes through the water line of water treatment management device 10. Based on the measured TOC value and concentration of specific organics, controller 32 controls the amount of oxidizer added to the treated water that passes through the UV irradiator provided in water treatment facility 233. Consistent and efficient removal of TOC can be achieved by controlling the amount of added oxidizer or the amount of UV irradiation based on measurements that take into account urea, which is difficult to remove by water treatment control device 10. In addition, the TOC removal performance can be improved by installing oxidizer addition means to precede the UV irradiator provided in water treatment facility 233 to treat the TOC. Whether controller 32 gives priority to controlling the amount of oxidizer added to the treated water or the amount of UV light irradiated by the UV irradiator may be determined by taking into consideration not only the treatment performance, but also the operating cost and the load upon the water treatment devices that follow the device.

### Fourth Embodiment

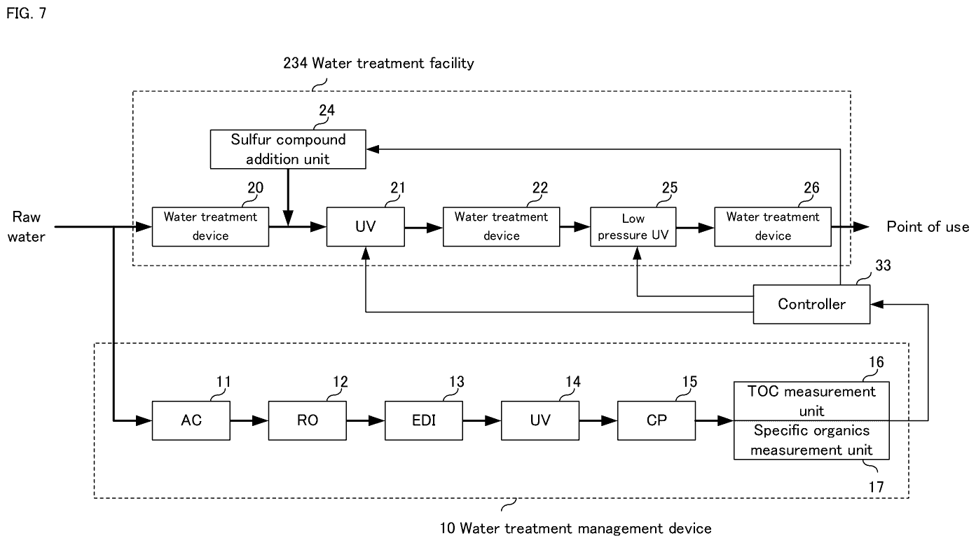

FIG. 7 is a diagram showing the fourth embodiment of a water treatment system of the present invention. As shown in FIG. 7, the water treatment system in this embodiment includes water treatment facility 234 equipped with water treatment device 20, UV 21 that is a UV irradiator, water treatment device 22, low-pressure UV 25 that is a UV irradiator whose internal pressure is less than a predetermined pressure (first pressure), and water treatment device 26. Raw water, which is treated water, is supplied to water treatment facility 234 (specifically, water treatment device 20). The supplied raw water is sequentially treated in water treatment device 20, UV 21, water treatment device 22, low-pressure UV 25, and water treatment device 26. This produces water of a predetermined quality (e.g., pure water). The produced water is supplied from water treatment device 26 to, for example, a point of use or another water treatment facility. The water treatment system in this embodiment also includes water treatment management device 10 to which is supplied at least a part of the treated water that is supplied to water treatment facility 234. Water treatment management device 10 is the same as in the first embodiment. The water treatment system in this embodiment further includes controller 33 and sulfur compound addition unit 24, which is an oxidizer addition means. Sulfur compound addition unit 24 is the same as in the third embodiment. Sulfur compound addition unit 24 may also be included in water treatment facility 234.

Controller 33 controls the operating conditions of the water treatment devices that constitute water treatment facility 234 based on the TOC concentration value (TOC value) output from TOC measurement unit 16 and the specific organics concentration value output from specific organics measurement unit 17. In this embodiment, controller 33 controls at least one of the following: the amount of UV irradiation irradiated by UV 21, the amount of UV irradiation irradiated by low-pressure UV 25, and the amount of oxidizer added by sulfur compound addition unit 24. For example, controller 33 changes (converts) the specific organics concentration value output from specific organics measurement unit 17 to a TOC value. This conversion is performed using the ratio of the atomic weight of the carbon in the organic molecules to the molecular weight of the organic (e.g., urea). Based on the difference or ratio between the TOC value output from TOC measurement unit 16 and the TOC value converted from the organic matter concentration value output from specific organics measurement unit 17, controller 33 may calculate at least one of the following: the amount of UV irradiation to be irradiated by UV 21, the amount of UV irradiation to be irradiated by low-pressure UV 25, and the amount of oxidizer added by sulfur compound addition unit 24. When calculating these irradiation doses and concentrations, controller 33 may use a predetermined calculation formula or correspondence to calculate the irradiation doses and concentration based on the difference or ratio between the TOC value output from TOC measurement unit 16 and the TOC value that was converted from the organic concentration value output from specific organics measurement unit 17. When calculating these irradiation doses and concentrations, controller 33 may calculate irradiation doses and concentrations by comparing the water quality (for example, the TOC value or dissolved oxygen concentration) of the water supplied from water treatment device 22 to the point of use at that time with a threshold value (one or more threshold values being possible) that is calculated in advance based on the difference or ratio between the TOC value output from TOC measurement unit 16 and the TOC value that is converted from the organic matter concentration value output from specific organics measurement unit 17. Controller 33 may also start or stop the operation of UV 21 and the addition of oxidizer from sulfur compound addition unit 24 based on the difference or ratio between the TOC value output from TOC measurement unit 16 and the TOC value that is converted from the organic concentration value output from specific organics measurement unit 17. For example, controller 33 may stop the operation of UV 21 and the addition of the oxidizer from sulfur compound addition unit 24 if the difference is less than a threshold value, and controller 33 may start the operation of UV 21 and the addition of the oxidizer from sulfur compound addition unit 24 if the difference is equal to or greater than the threshold value.

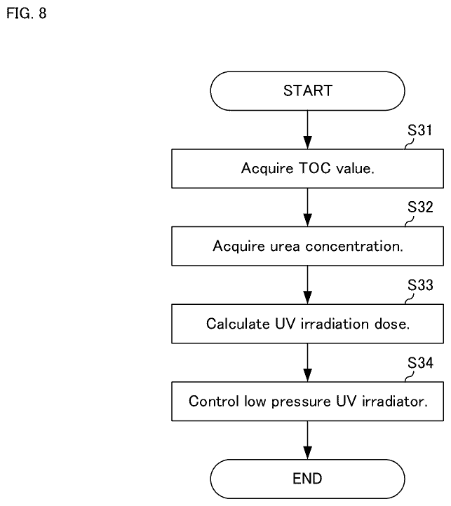

The process in controller 33 shown in FIG. 7 is next described. FIG. 8 is a flowchart for explaining an example of processing in controller 33 shown in FIG. 7. The following is an example in which specific organics measurement unit 17 measures the concentration of urea and in which controller 33 controls the UV irradiation dose irradiated by low-pressure UV 25.

First, controller 33 acquires the TOC value measured by TOC measurement unit 16 (Step S31). Controller 33 also acquires the value of the urea concentration measured by specific organics measurement unit 17 (Step S32). Controller 33 converts the acquired urea concentration value to a TOC value. Controller 33 calculates the UV irradiation dose irradiated by low-pressure UV 25 based on the acquired TOC value and the TOC value that was converted from the urea concentration (Step S33). Controller 33 then controls low-pressure UV 25 such that low-pressure UV 25 irradiates the calculated irradiation dose (Step S34).

Thus, in this embodiment, water treatment management device 10 is provided to which at least a part of the treated water to be supplied to water treatment facility 234 is passed (supplied), and measurement instruments measure the TOC value and the concentration of specific organics in the water being passed through the water line of water treatment management device 10. Based on the measured TOC value and specific organics concentration, controller 33 controls at least one of the following: the amount of UV irradiation from the UV irradiator provided in water treatment facility 234, the amount of UV irradiation from the low-pressure UV irradiator provided in water treatment facility 234, and the amount of oxidizer added to the treated water that is passed through the UV irradiator. Efficient removal of TOC can be achieved by controlling the UV irradiation dose and the amount of oxidizer added based on measurements that take into account urea, which is difficult to remove in a water treatment management device. The embodiment shown in FIG. 7 shows an embodiment in which low-pressure UV 25 is located to follow UV 21, but low-pressure UV 25 may be located to precede UV 21.

By arranging low-pressure UV 25 separate from UV 21 as the UV irradiator as in this embodiment, treated water to which an oxidizer (sulfur compound) has been added from sulfur compound addition unit 24 need not be constantly subjected to UV irradiation by UV 21. In addition, low-pressure UV 25 can be operated at low concentration and with less irradiation. Therefore, TOC in the treated water can be removed efficiently. For example, if the specified organic matter is urea, control using the addition of sulfur compounds and irradiation of ultraviolet light is performed only when the ratio of urea to TOC is higher than a predetermined threshold value, whereby TOC can be efficiently removed from the treated water. Generally, medium- or high-pressure UV irradiation is used for UV treatment with sulfur compounds. Since medium-pressure and high-pressure UV consume more power, the use of low-pressure UV can reduce power consumption.

When low-pressure UV 25, which is separate from UV 21, is arranged as a UV irradiator as in this embodiment, the amount of UV irradiation irradiated by low-pressure UV 25 and the amount of oxidizer added by sulfur compound addition unit 24 are controlled based on the TOC value measured by TOC measurement unit 16 and the urea concentration value measured by specific organics measurement unit 17. This arrangement allows for more efficient removal of TOC from the treated water. The UV irradiation dose irradiated by low-pressure UV 25 may be reduced during operation in which UV irradiation is applied to treated water to which an oxidizer has been added from sulfur compound addition unit 24. For example, if the specific organic matter is urea, which is difficult to break down, two threshold values (threshold A>threshold B) are set in advance using the ratio of the TOC conversion value of the urea concentration measured by specific organics measurement unit 17 to the TOC value measured by TOC measurement unit 16. If the ratio at the time of measurement is equal to or greater than threshold value A, controller 33 may control the amount of oxidizer added by sulfur compound addition unit 24 and the amount of UV irradiation irradiated by UV 21 (including starting and stopping the operation of sulfur compound addition unit 24 and UV 21) based on that ratio, and if the ratio at the time of measurement is less than or equal to threshold value B, controller 33 may control the amount of UV irradiation irradiated by low-pressure UV 25 (including starting and stopping the operation of low pressure UV 25) based on that ratio.

If a device for treating urea is provided in main water treatment facility 234, two threshold values (threshold value C<threshold value D) are set in advance using the ratio of the TOC conversion value of the urea concentration measured by specific organics measurement unit 17 to the TOC value measured by TOC measurement unit 16. If the ratio at the time of measurement is less than or equal to threshold value C, controller 33 may control the amount of oxidizer added by sulfur compound addition unit 24 (including starting and stopping the operation of sulfur compound addition unit 24), and if the ratio at the time of measurement is equal to or greater than threshold value D, controller 33 may control the amount of UV irradiation irradiated by low-pressure UV 25 (including starting and stopping the operation of low-pressure UV 25) based on that ratio. Controller 33 may use these ratios or may also use the difference or ratio between the TOC value measured by TOC measurement unit 16 and the TOC conversion value of the urea concentration measured by specific organics measurement unit 17. In this way, consistent treatment is possible even when organic matter that is difficult to break down other than urea is mixed in.

### Fifth Embodiment

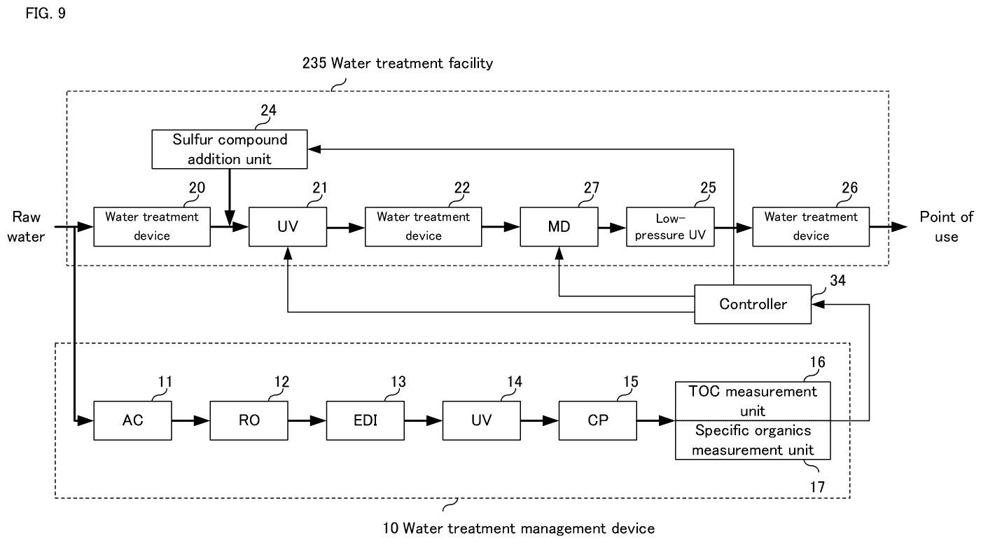

FIG. 9 is a diagram showing the fifth embodiment of a water treatment system of the present invention. As shown in FIG. 9, the water treatment system in this embodiment includes water treatment facility 235 equipped with water treatment device 20, UV 12 that is a UV irradiator, water treatment device 22, MD 27 that is a degasser, a low-pressure UV 25 that is a UV irradiator whose internal pressure is less than a predetermined pressure (first pressure), and water treatment device 26. Raw water, which is treated water, is supplied to water treatment facility 235 (specifically, water treatment device 20). The supplied raw water is sequentially treated in water treatment device 20, UV 21, water treatment device 22, MD 27, low-pressure UV 25 and water treatment device 26. This produces water of a predetermined quality (e.g., pure water). The produced water is supplied from water treatment device 26 to, for example, a point of use or another water treatment facility. The water treatment system in this embodiment also includes water treatment management device 10 to which is supplied at least a part of the treated water that is supplied to water treatment facility 235. Water treatment management device 10 is the same as in the first embodiment. Furthermore, the water treatment system in this embodiment includes controller 34 and sulfur compound addition unit 24, which is an oxidizer addition means. Sulfur compound addition unit 24 is the same as in the third embodiment. Sulfur compound addition unit 24 may be included in water treatment facility 235.

Controller 34 controls the operating conditions of the water treatment devices that constitute water treatment facility 235 based on the TOC concentration value (TOC value) output from TOC measurement unit 16 and the organic matter concentration value output from specific organics measurement unit 17. In this embodiment, controller 34 controls at least one of the following: the amount of UV irradiation irradiated by UV 21, the dissolved oxygen concentration of the treated water of UV 21 that is controlled by MD 27, and the amount of oxidizer added by sulfur compound addition unit 24. For example, controller 34 changes (converts) the value of the organic matter concentration output from specific organics measurement unit 17 to a TOC value. This conversion is performed using the ratio of the atomic weight of the carbon in the organic molecules to the molecular weight of the organic (e.g., urea). Based on the difference or ratio between the TOC value output from TOC measurement unit 16 and the TOC value that is converted from the organic matter concentration value output from specific organics measurement unit 17, controller 34 may calculate at least one of the following: the UV irradiation dose to be irradiated by UV 21, the dissolved oxygen concentration of the treated water in UV 21 controlled by MD 27, and the amount of oxidizer added by sulfur compound addition unit 24. When calculating the amount of irradiation, the dissolved oxygen concentration, and the amount of added oxidizer, controller 34 may use a predetermined calculation formula or correspondence to calculate the irradiation dose, the dissolved oxygen concentration, and the amount of added oxidizer based on the difference or ratio between the TOC value output from TOC measurement unit 16 and the TOC value converted from the organic matter concentration value output from specific organics measurement unit 17. When calculating the amount of irradiation, the dissolved oxygen concentration, and the amount of added oxidizer, controller 34 may compare the water quality (e.g., the TOC value or dissolved oxygen concentration) of the water to be supplied from the water treatment device 26 to the point of use at that time with a threshold value (one or more threshold values being possible) that is calculated in advance based on the difference or ratio between the TOC value output from TOC measurement unit 16 and the TOC value that was converted from the organic matter concentration value output from specific organics measurement unit 17. Controller 34 may also start or stop the operation of UV 21 and the addition of oxidizer from sulfur compound addition unit 24 based on the difference or ratio between the TOC value output from TOC measurement unit 16 and the TOC value that was converted from the organic concentration value output from specific organics measurement unit 17. For example, controller 34 may stop the operation of UV 21 and the addition of the oxidizer from sulfur compound addition unit 24 if the difference is less than the threshold value, and controller 34 may start the operation of UV 21 and the addition of the oxidizer from sulfur compound addition unit 24 if the difference is equal to or greater than the threshold value.

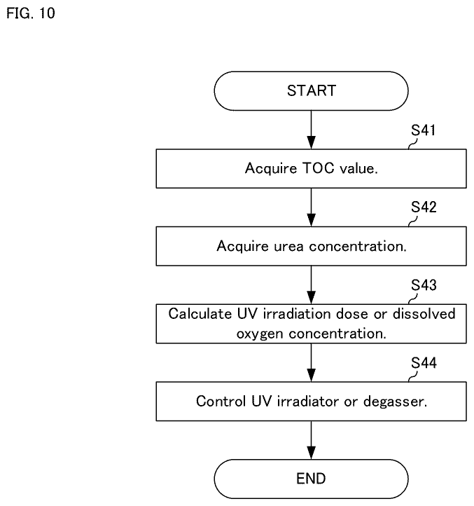

The process in controller 34 shown in FIG. 9 is next described. FIG. 10 is a flowchart for explaining an example of processing in controller 34 shown in FIG. 9. The following is an example in which specific organics measurement unit 17 measures the concentration of urea and in which controller 34 controls the amount of UV irradiation irradiated by UV 21 or the concentration of dissolved oxygen in the treated water.

First, controller 34 acquires the TOC value measured by TOC measurement unit 16 (Step S41). Controller 34 further acquires the value of the urea concentration measured by specific organics measurement unit 17 (Step S42). Controller 34 converts the acquired urea concentration value to a TOC value. Based on the acquired TOC value and the TOC value that was converted from the urea concentration, controller 34 calculates the UV irradiation dose irradiated by UV 21 or the dissolved oxygen concentration of the treated water in UV 21 that is controlled by MD 27 (Step S43). Controller 34 then controls UV 21 such that UV 21 irradiates the calculated amount of irradiation or controls MD 27 such that the dissolved oxygen concentration in the treated water becomes the calculated dissolved oxygen concentration (Step S44).

Thus, in this embodiment, water treatment management device 10 is provided to which is supplied at least a part of the treated water directed to water treatment facility 235, and measurement instruments measure the TOC value and the concentration of specific organics in the water being passed through the water line of water treatment management device 10. Based on the measured TOC value and organic matter concentration, controller 34 controls at least one of the following: the amount of UV irradiation from the UV irradiator provided in water treatment facility 235, the dissolved oxygen concentration of the treated water in the UV irradiator that is controlled by the degasser, and the amount of the oxidizer added to the treated water that is passed through the UV irradiator. Controller 34 controls the amount of UV irradiation, the dissolved oxygen concentration in the treated water, and the amount of oxidizer added based on measurements that take into account urea, which is difficult to remove in a water treatment management device. This arrangement enables efficient TOC removal.

When low-pressure UV 25 is arranged separately from UV 21 as a UV irradiator as in this embodiment, the dissolved oxygen in the treated water of low-pressure UV 25 that is controlled by MD 27 that is arranged preceding low-pressure UV 25 and the amount of oxidizer added by sulfur compound addition unit 24 are controlled based on the TOC value measured by TOC measurement unit 16 and the value of the urea concentration measured by specific organics measurement unit 17. This arrangement enables more efficient removal of TOC. The amount of UV irradiation from low-pressure UV 25 may be controlled so as to be less during operation in which UV irradiation is applied to treated water to which an oxidizer is added from sulfur compound addition unit 24. For example, if the specific organic matter is urea, which is difficult to break down, two threshold values (threshold A>threshold B) may be set in advance using the ratio of the TOC conversion value of the urea concentration measured by specific organics measurement unit 17 to the TOC value measured by TOC measurement unit 16. If the ratio at the time of measurement is equal to or greater than threshold value A, controller 34 may control the amount of oxidizer added by sulfur compound addition unit 24 (including starting and stopping the operation of sulfur compound addition unit 24) based on that ratio, and if the ratio at the time of measurement is less than or equal to threshold value B, controller 34 may control the amount of UV irradiation irradiated by low-pressure UV 25 (including starting and stopping the operation of low-pressure UV 25) based on that ratio.

If a device for treating urea is provided in main water treatment facility 235, two threshold values (threshold value C<threshold value D) may be set in advance using the ratio of the TOC conversion value of the urea concentration measured by specific organics measurement unit 17 to the TOC value measured by TOC measurement unit 16. If the ratio at the time of measurement is less than or equal to threshold value C, controller 34 controls the amount of oxidizer added by sulfur compound addition unit 24 (including starting or stopping the operation of sulfur compound addition unit 24), and if the ratio at the time of measurement is equal to or greater than threshold value D, controller 34 controls the amount of UV irradiation irradiated by low-pressure UV 25 (including starting or stopping the operation of low-pressure UV 25) based on that ratio. Controller 34 may use these ratios or may use the difference or ratio between the TOC value measured by TOC measurement unit 16 and the TOC conversion value of the urea concentration measured by specific organics measurement unit 17. In this way, consistent treatment is possible even when organic matter that is difficult to break down other than urea is mixed in.

### Sixth Embodiment

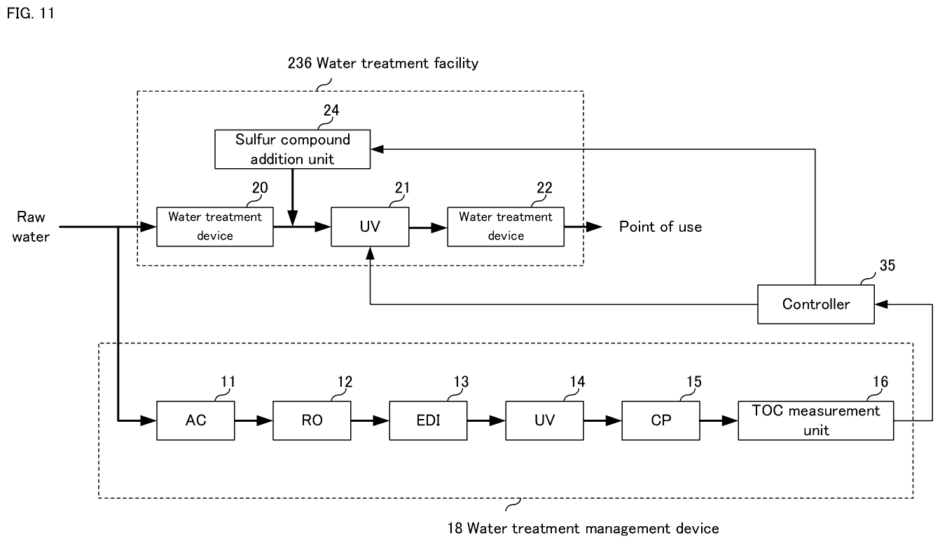

FIG. 11 is a diagram showing the sixth embodiment of a water treatment system of the present invention. As shown in FIG. 11, the water treatment system in this embodiment includes water treatment facility 236 that is equipped with water treatment device 20, UV 21 that is a UV irradiator, and water treatment device 22. Raw water, which is treated water, is supplied to water treatment facility 236 (specifically, water treatment device 20). The supplied raw water is sequentially treated in water treatment device 20, UV 21, and water treatment device 22. This produces water of a predetermined quality (e.g., pure water). The produced water is supplied from water treatment device 22 to, for example, a point of use or another water treatment facility. The water treatment system in this embodiment also includes water treatment management unit 18 to which is supplied at least a part of the treated water that is directed to water treatment facility 236. Water treatment management device 18 includes the components of water treatment management device 10 in the first embodiment with the exception of specific organics measurement unit 17. The water treatment system in this embodiment further includes controller 35 and sulfur compound addition unit 24, which is an oxidizer addition means. Sulfur compound addition unit 24 is the same as in the third embodiment. Sulfur compound addition unit 24 may also be included in water treatment facility 236.

Controller 35 controls the operating conditions of the water treatment devices that constitute water treatment facility 236 based on the TOC concentration value (TOC value) output from TOC measurement unit 16. In this embodiment, controller 35 controls at least one of the following: the amount of UV irradiation irradiated by UV 21 and the amount of oxidizer added by sulfur compound addition unit 24. For example, controller 35 may calculate at least one of the UV irradiation dose irradiated by UV 21 and the amount of oxidizer added by sulfur compound addition unit 24 based on the TOC value output from TOC measurement unit 16. Controller 35 may use a predetermined calculation formula or correspondence to calculate the UV irradiation dose or the amount of oxidizer added based on the TOC value output from TOC measurement unit 16. Controller 35 may calculate the UV irradiation dose and the amount of oxidizer added by comparing the water quality (for example, the TOC value and dissolved oxygen concentration) of the water supplied from water treatment device 22 to the point of use at that time with a pre-calculated threshold value (one or more threshold values being possible) based on the TOC value output from TOC measurement unit 16. Controller 35 controls UV 21 to irradiate the calculated UV irradiation dose and controls sulfur compound addition unit 24 to add the calculated concentration of oxidizer. Controller 35 may also start or stop the operation of UV 21 and the addition of oxidizer from sulfur compound addition unit 24 based on the TOC value output from TOC measurement unit 16. For example, controller 35 may stop the UV 21 operation and the addition of oxidizer from sulfur compound addition unit 24 if the TOC value output from TOC measurement unit 16 is less than a threshold value and may start the operation of UV 21 and the addition of oxidizer from sulfur compound addition unit 24 if the TOC value output from TOC measurement unit 16 is equal to or greater than the threshold value.

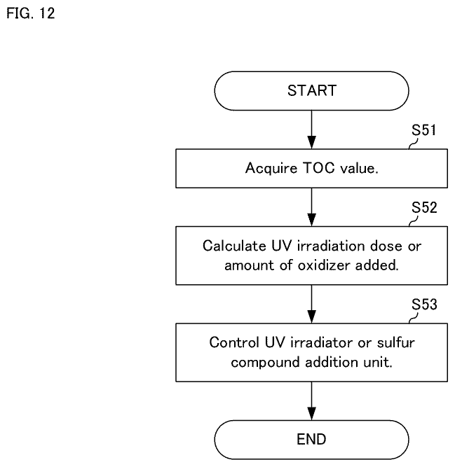

The process in controller 35 shown in FIG. 11 is next described. FIG. 12 is a flowchart for explaining an example of processing in controller 35 shown in FIG. 11. The following is an example in which controller 35 controls the UV irradiation dose irradiated by UV 21 or the amount of oxidizer added by sulfur compound addition unit 24.

First, controller 35 acquires the TOC value measured by TOC measurement unit 16 (Step S51). Controller 35 then calculates the UV irradiation dose to be irradiated by UV 21 or the amount of oxidizer added by sulfur compound addition unit 24 based on the acquired TOC value (Step S52). When calculating the UV irradiation dose irradiated by UV 21 in Step S52, controller 35 controls UV 21 such that UV light of the calculated irradiation dose is irradiated from UV 21. Alternatively, if the amount of oxidizer to be added by sulfur compound addition unit 24 has been calculated in Step S52, controller 35 controls sulfur compound addition unit 24 such that the calculated concentration of oxidizer is added (Step S53).

Thus, in this embodiment, water treatment management device 18 is provided to which is supplied at least a part of the treated water directed to water treatment facility 236, and a measurement instrument measures the TOC value in the water being passed through the water line of water treatment management device 18. Based on the measured TOC value, controller 35 controls at least one of the UV irradiation dose from the UV irradiator provided in water treatment facility 236 and the amount of oxidizer added to the treated water that is passed through the UV irradiator. This enables consistent and efficient TOC removal. In addition, the TOC removal performance can be improved by installing an oxidizer addition means that precedes the UV irradiator to treat the TOC.

In the first through sixth embodiments described above, the treated water that is passed through water treatment management devices 10 and 18 is not limited to raw water, but can be any of the treated water in the water treatment system. If the raw water is regenerated or recovered water, it may be treated water from any of the water treatment devices in the system that produces the regenerated or recovered water. Multiple water treatment management devices 10 and 18 may be installed depending on the water to be treated. In addition to the measurement values of treated water in the water treatment management device, the amount of UV irradiation in the water treatment system may be controlled based on the amount of UV irradiation and dissolved oxygen concentration in the water treatment management device.

### EXAMPLES

### Example 1-1

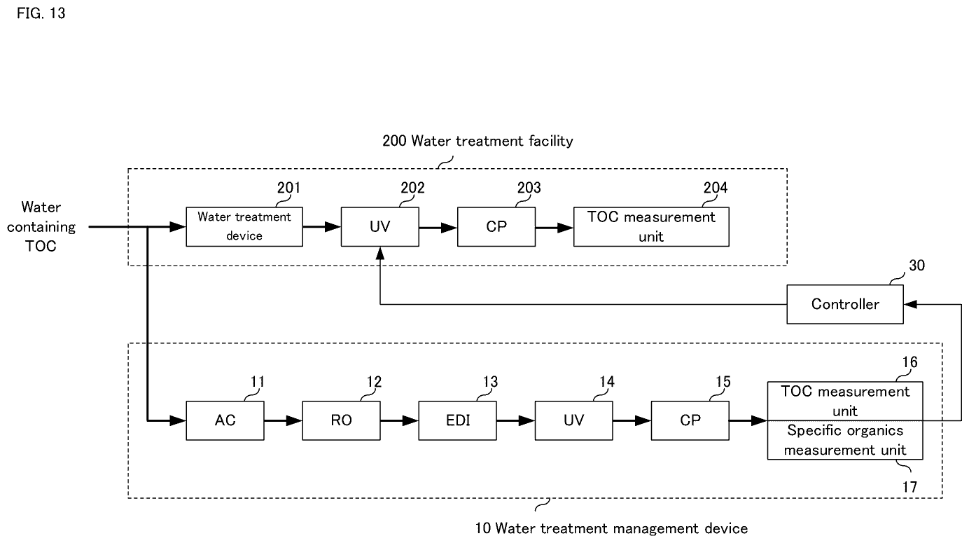

FIG. 13 is a diagram showing the configuration for Example 1-1 of the water treatment system of the present invention. As shown in FIG. 13, water treatment management device 10 was arranged in parallel with water treatment facility 200, which consisted of water treatment device 201 for pretreatment, UV irradiator (UV) 202, and ion exchange resin-filled device (CP) 203. Water containing TOC was caused to flow through for treatment. TOC measurement unit 204 measured the treated water in CP 203. Water treatment device 201 functioned to remove urea from water that contained TOC. Water treatment management device 10 was as in the embodiments described above. TOC measurement unit 16 and specific organics measurement unit 17 were arranged in the water treatment line of water treatment management device 10. The amount of UV irradiation irradiated by UV 202 was set and controlled by controller 30 based on the measured values (the difference between the value measured by the TOC measurement unit 16 and the TOC conversion value of the urea measured by specific organics measurement unit 17) acquired from water treatment management device 10.

### Comparative Example 1-1

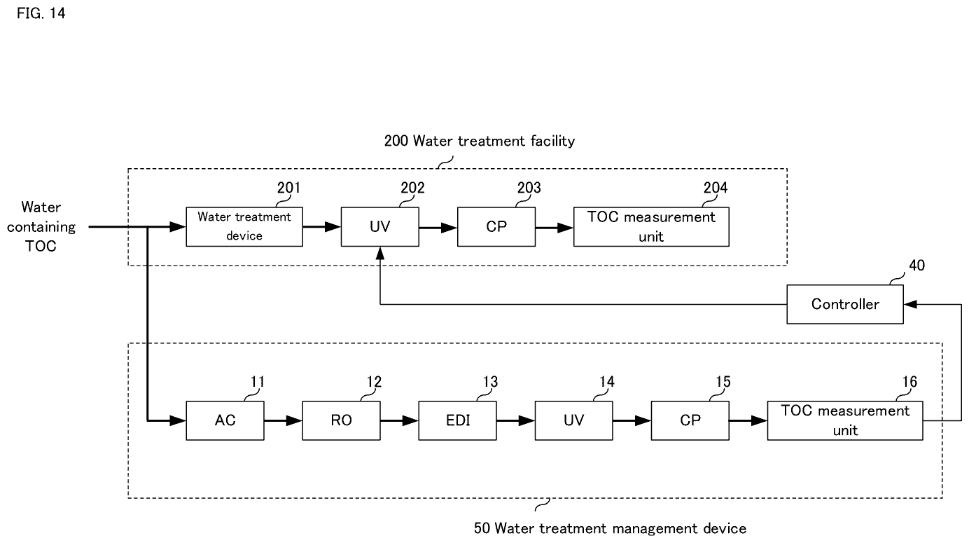

FIG. 14 is a diagram showing the configuration for Comparative Example 1-1, which was compared with Example 1-1. As shown in FIG. 14, water treatment management device 50 was arranged in parallel with the same water treatment facility 200 shown in FIG. 13, and water that contained TOC was caused to flow through for treatment. TOC measurement unit 204 measured the treated water in CP 203. Water treatment management device 50 had a configuration in which specific organics measurement unit 17 was omitted from water treatment management device 10 shown in FIG. 13. As in Example 1-1, the amount of UV irradiation irradiated by UV 202 was controlled by controller 40 based on the measured values acquired from water treatment management device 50 (the values measured by TOC measurement unit 16) using the same relationship between measured values and the amount of irradiation.

### Example 1-2

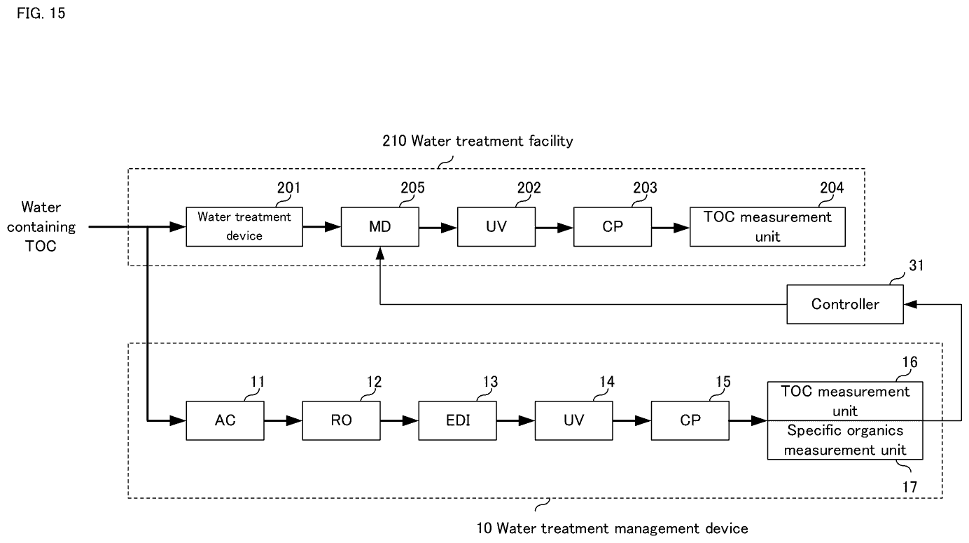

FIG. 15 is a diagram showing the configuration for Example 1-2 of the water treatment system of the present invention. As shown in FIG. 15, water treatment facility 210 was equipped with MD 205, which was a degasser. MD 205 was arranged to precede UV 202 that was included in the configuration for Example 1-1 shown in FIG. 13, and water that contained TOC was similarly caused to flow through for treatment. TOC measurement unit 204 measured the treated water from CP 203. The configuration shown in FIG. 13 for Example 1-1 included water treatment management device 10. A vacuum degassing membrane with a degassing membrane and a vacuum pump was used as MD 205, and based on the measured values (the difference between the measured values measured by TOC measurement unit 16 and the TOC conversion value of the urea measured by specific organics measurement unit 17) acquired from water treatment management device 10, controller 31 set the dissolved oxygen concentration (DO concentration) of the UV-treated water and adjusted and controlled the vacuum of MD 205 such that the measured value of the dissolved oxygen meter was equal to the set value. The dissolved oxygen meter was arranged between MD 205 and UV 202.

### Comparison Example 1-2

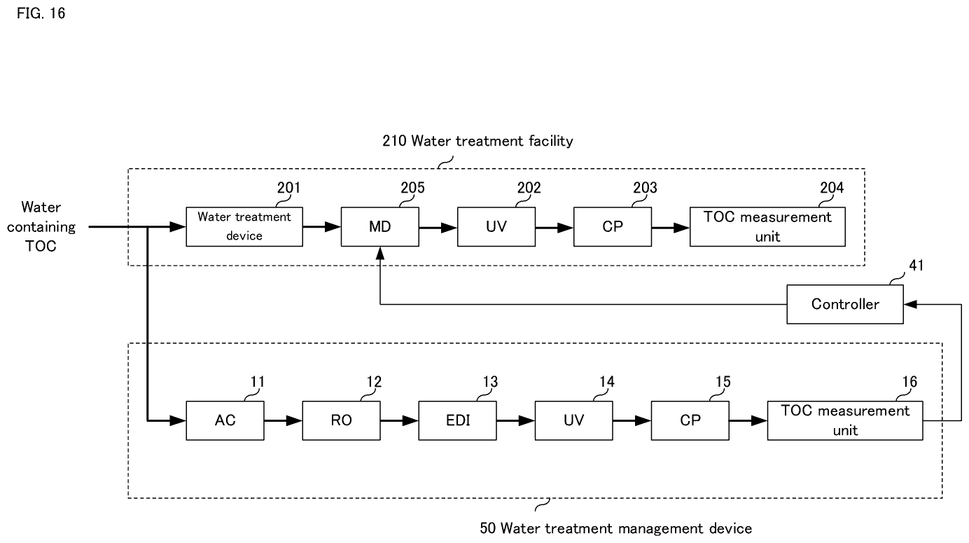

FIG. 16 is a diagram showing the configuration for Comparative Example 1-2, which was compared with Example 1-2. As shown in FIG. 16, water treatment management device 50 was arranged in parallel with the same water treatment facility 210 shown in FIG. 15, and water that contained TOC was caused to flow through for treatment. TOC measurement unit 204 measured the treated water of CP 203. The configuration of water treatment management device 50 omitted specific organics measurement unit 17 from water treatment management device 10 shown in FIG. 15. Controller 41 used the same relationship between a measured value and dissolved oxygen concentration as in Example 1-2 to control the dissolved oxygen concentration (DO concentration) based on the measured value (the value measured by TOC measurement unit 16) acquired from water treatment management device 50.

Details of the test conditions for Examples 1-1 and 1-2 and Comparative Examples 1-1 and 1-2 are shown below:
UV irradiator. Low-pressure UV oxidation device, Japan Photo Science Co.
Ion exchange resin-filled device: Strong acid cation exchange resin AMBERJET 1024 H type (Organo Corporation), Strong base anion exchange resin AMBERJET 4002 OH type (Organo Corporation) Mixed-bed filling
Means of measuring specific organics (urea): ORUREA by Organo
Water treatment device: Consists of urea removal device, filtration device, activated carbon, ion exchange resin-filled device, and reverse osmosis membrane device
TOC concentration of water containing TOC: 500-700 ppb-C
TOC meter: Sievers M500e
Reverse osmosis membrane device for water treatment management device: Two-stage treatment Irradiation dose control: Controlled by number of lamps lit
Degasser: Vacuum degassing membrane
Dissolved oxygen control: Adjusted the vacuum level of the degasser using an inverter
DO concentration of treated water: 1 ppm
Urea remover: Retention tank with added sodium hypochlorite and sodium bromide

The results of Examples 1-1 and 1-2 and Comparative Examples 1-1 and 1-2 are shown in Tables 1 and 2. The “urea-TOC conversion value” in Tables 1 and 2 is the value obtained by converting the concentration of urea measured by specific organics measurement unit 17 to a TOC value (the same applies in the following examples).

TABLE 1

| | Water containing TOC ppb-C | | | |
|---|---|---|---|---|
| | TOC | TOC | | UV |
| | measurement | measurement | Urea-TOC | irradiation |
| | unit | unit | conversion | dose |
| | 204 | 16 | value | kWh/m³ |
| Example 1-1 | <0.5 | 2.3 | 1.5 | 0.1 |
| | <0.5 | 3.1 | 2.4 | 0.1 |
| Comparative | <0.5 | 2.1 | — | 0.2 |
| Example 1-1 | <0.5 | 3.2 | — | 0.3 |

TABLE 2

| | Water containing TOC ppb-C | | | |
|---|---|---|---|---|
| | TOC | TOC | | |
| | measurement | measurement | Urea-TOC | DO |
| | unit | unit | conversion | concentration |
| | 204 | 16 | value | ppm |
| Example 1-2 | <0.5 | 2.4 | 1.5 | 1 |
| | <0.5 | 3.0 | 2.2 | 1 |
| Comparative | <0.5 | 2.2 | — | 0.5 |
| Example 1-2 | <0.5 | 3.3 | — | 0.1 |

As shown in Table 1, the values measured by TOC measurement unit 204 in both Example 1-1 and Comparative Example 1-1 were maintained below 0.5 ppb. The UV irradiation dose irradiated by UV 202 in Example 1-1 was 0.1 kWh/m³, while the UV irradiation dose irradiated by UV 202 in Comparative Example 1-1 was increased to 0.2 to 0.3 kWh/m³ and controlled. This is because in Comparative Example 1-1, the UV irradiation dose was controlled using measured values that included TOC derived from urea, which is difficult to remove by UV treatment. The irradiation dose was therefore excessive for TOCs other than urea. The results showed that by controlling the UV irradiation dose using a TOC measured value that excluded the urea measured value (TOC conversion value), the UV irradiation dose could be controlled without using an excessive irradiation dose. As shown in Table 2, by controlling the dissolved oxygen concentration using TOC measured values that exclude the measured value of urea (TOC conversion value) in the same manner as in Examples 1-2 and 1-2, the dissolved oxygen concentration could be controlled without excessively reducing the dissolved oxygen concentration.

### Example 2-1

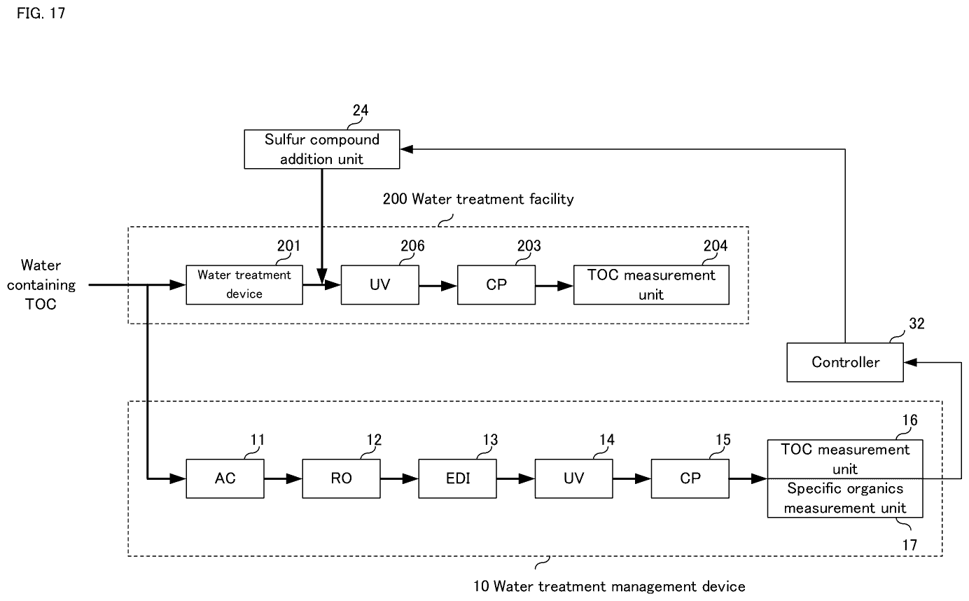

FIG. 17 is a diagram showing the configuration for Example 2-1 of the water treatment system of the present invention. As shown in FIG. 17, water treatment management device 10 was arranged in parallel with water treatment facility 200, which consisted of water treatment device 201 for pretreatment, UV irradiator (UV) 206 that was a medium-pressure UV device, and ion exchange resin-filled device (CP) 203. Water containing TOC was caused to flow through for treatment. Water treatment management device 10 was the same as in the previously described embodiments. TOC measurement unit 16 and specific organics measurement unit 17 were arranged in the water treatment line of water treatment management device 10. In addition, sulfur compound addition unit 24 was provided to add an oxidizer to the treated water that passed through UV 206. Sulfur compound addition unit 24 could also be included in water treatment facility 200. Controller 32 set and controlled the amount of oxidizer added by sulfur compound addition unit 24 based on the measured value (the difference between the value measured by TOC measurement unit 16 and the TOC conversion value of the urea measured by specific organics measurement unit 17) acquired from water treatment management device 10. The results are shown in Table 3. As in Examples 1-1 and 1-2, the values measured by TOC measurement unit 204 were less than 0.5 ppb, a result that indicates stable processing.

TABLE 3

Water containing TOC ppb-C

| | TOC | TOC | |
|---|---|---|---|
| | measurement | measurement | Urea-TOC |
| | unit | unit | conversion |
| | 204 | 16 | value |
| Example 2-1 | <0.5 | 2.4 | 0.3 |
| | <0.5 | 2.5 | 1.5 |

### Example 2-2

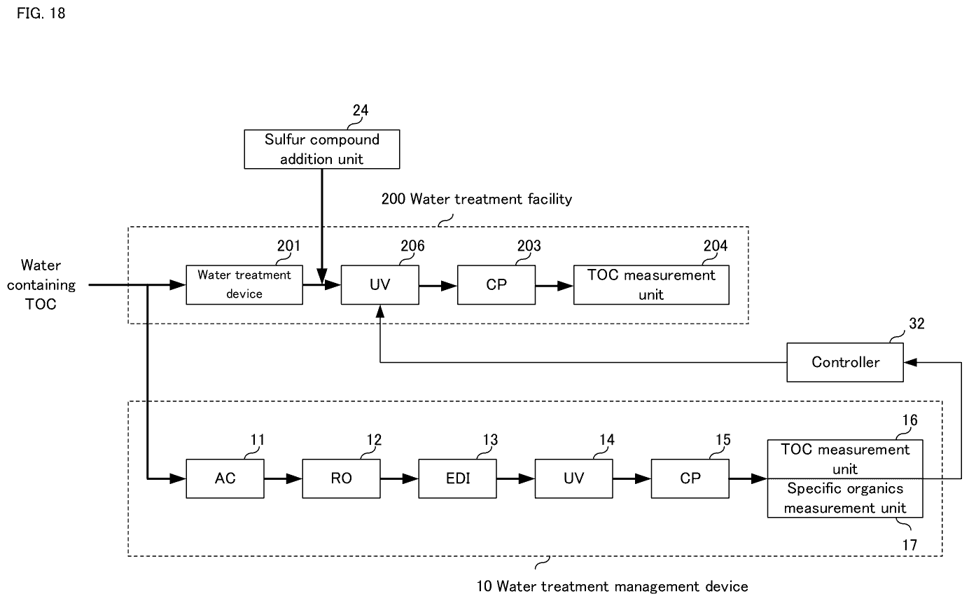

FIG. 18 is a diagram showing the configuration for Example 2-2 of the water treatment system of the present invention. As shown in FIG. 18, the configuration for Example 2-2 was the same as that shown in FIG. 17. Controller 32 set and controlled the UV irradiation dose irradiated by the UV 206 based on the measured values acquired from water treatment management device 10 (the difference between the value measured by TOC measurement unit 16 and the TOC conversion value of the urea measurement value measured by specific organics measurement unit 17). The results are shown in Table 4. As in Examples 1-1 and 1-2, the values measured by TOC measurement unit 204 were less than 0.5 ppb, a result that indicates stable processing.

TABLE 4

Water containing TOC ppb-C

| | TOC | TOC | |
|---|---|---|---|
| | measurement | measurement | Urea-TOC |
| | unit | unit | conversion |
| | 204 | 16 | value |
| Example 2-2 | <0.5 | 2.6 | 0.4 |
| | <0.5 | 2.4 | 1.3 |

### Example 3-1

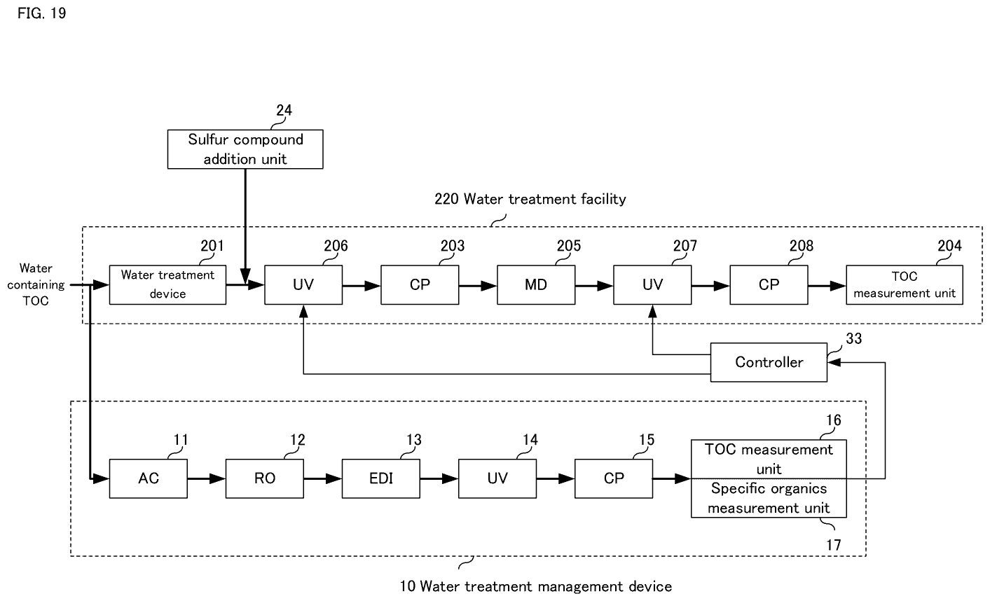

FIG. 19 is a diagram showing the configuration for Example 3-1 of the water treatment system of the present invention. As shown in FIG. 19, water treatment management device 10 was arranged in parallel with water treatment facility 220, which consisted of water treatment device 201 for pretreatment, UV irradiator (UV) 206, ion exchange resin-filled device (CP) 203, degasser (MD) 205, low-pressure UV irradiator (UV) 207, and ion exchange resin-filled device (CP) 208. Water containing TOC was caused to flow through for treatment. Water treatment management device 10 was the same as in the embodiments described above. TOC measurement unit 16 and specific organics measurement unit 17 were arranged in the water treatment line of water treatment management device 10. Controller 33 set and controlled the UV irradiation doses irradiated by UV 206 and 207 based on the measured value acquired from water treatment management device 10 (the difference between the value measured by TOC measurement unit 16 and the TOC conversion value of the urea measured by the specific organics measurement unit 17). Two threshold values (threshold E>threshold F) were set in advance, and controller 33 controlled the UV irradiation dose irradiated by the UV 206 if the difference between the value measured by TOC measurement unit 16 and the TOC conversion value of the urea measurement value measured by specific organics measurement unit 17 was equal to or greater than threshold value E. If the difference between the value measured by TOC measurement unit 16 and the TOC conversion value of the urea measurement value measured by specific organics measurement unit 17 was less than threshold value E and equal to or greater than threshold value F, controller 33 controlled the UV irradiation dose irradiated by each of UV 206 and 207 at a constant value. If the difference between the value measured by TOC measurement unit 16 and the TOC conversion value of the urea measurement value measured by specific organics measurement unit 17 was less than threshold value F, controller 33 controlled the UV irradiation dose irradiated by UV 207. The results are shown in Table 5. The values measured by TOC measurement unit 204 were less than 0.5 ppb, a result that indicates stable processing. Sulfur compound addition unit 24 could also be included in water treatment facility 220.

TABLE 5

Water containing TOC ppb-C

| | TOC | TOC | |
|---|---|---|---|
| | measurement | measurement | Urea-TOC |
| | unit | unit | conversion |
| | 204 | 16 | value |
| Example 3-1 | <0.5 | 2.5 | 0.4 |
| | <0.5 | 2.3 | 0.8 |
| | <0.5 | 2.0 | 1.6 |

### Example 3-2

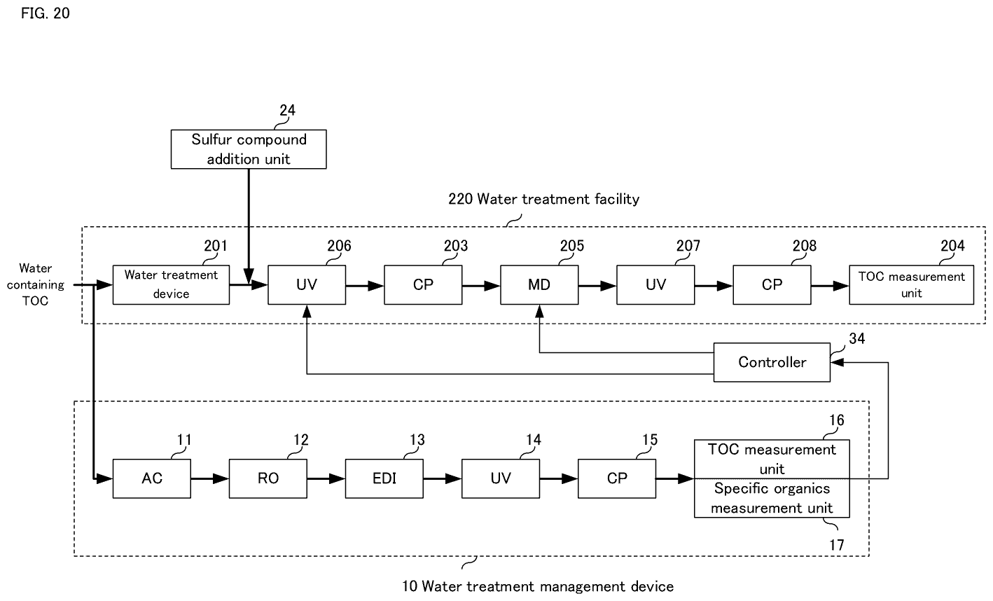

FIG. 20 is a diagram showing the configuration for Example 3-2 of the water treatment system of the present invention. As shown in FIG. 20, the configuration for Example 3-2 was the same as that shown in FIG. 19. Controller 34 set the UV irradiation dose irradiated by UV 206 and the dissolved oxygen concentration of the UV treated water based on the measured values acquired from water treatment management device 10 (the difference between the measured values by TOC measurement unit 16 and the TOC conversion value of the urea measured by specific organics measurement unit 17), and controlled the vacuum level of MD 205 by adjusting the vacuum level of MD 205 to achieve the set values. In this case, two threshold values (threshold G>threshold H) were set in advance. If the difference between the value measured by TOC measurement unit 16 and the TOC conversion value of the urea measurement value measured by specific organics measurement unit 17 was equal to or greater than threshold value G, controller 34 controlled the UV irradiation dose irradiated by UV 206. If the difference between the value measured by TOC measurement unit 16 and the TOC conversion value of the urea measurement value measured by specific organics measurement unit 17 was less than threshold value G and equal to or greater than threshold value H, controller 34 controlled the UV irradiation dose irradiated by UV 206 and the dissolved oxygen concentration of the UV treated water of UV 206 to a constant value. If the difference between the value measured by TOC measurement unit 16 and the TOC conversion value of the urea measurement value measured by specific organics measurement unit 17 was less than threshold value H, controller 34 set the dissolved oxygen concentration of the UV treated water and adjusted and controlled the vacuum of MD 205 to achieve that set value. The results are shown in Table 6. The values measured by TOC measurement unit 204 were less than 0.5 ppb, a result that indicates stable processing.

TABLE 6

Water containing TOC ppb-C

| | TOC | TOC | |
|---|---|---|---|
| | measurement | measurement | Urea-TOC |
| | unit | unit | conversion |
| | 204 | 16 | value |
| Example 3-2 | <0.5 | 2.3 | 0.2 |
| | <0.5 | 2.1 | 0.9 |
| | <0.5 | 2.4 | 2.0 |

### Example 4-1

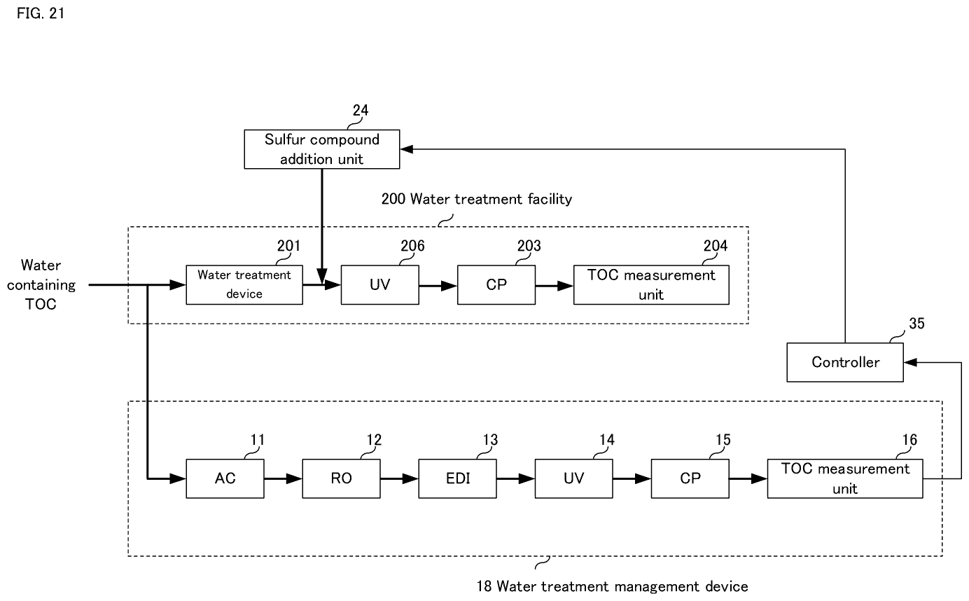

FIG. 21 is a diagram showing the configuration for Example 4-1 of the water treatment system of the present invention. As shown in FIG. 21, water treatment management device 18 was arranged in parallel with water treatment facility 200, which consisted of water treatment device 201 for pretreatment, UV irradiator (UV) 206 that was a medium-pressure UV device, and ion exchange resin filling device (CP) 203. Water containing TOC was caused to flow through for treatment. Water treatment management device 18 was the same as in the embodiments described above. TOC measurement unit 16 was arranged in the water treatment line of water treatment management device 18. In addition, sulfur compound addition unit 24 was provided to add an oxidizer to the treated water that passed through UV 206. Sulfur compound addition unit 24 could also be included in water treatment facility 200. Water treatment device 201 did not have a urea removal function. Controller 35 set and controlled the concentration of persulfuric acid added by sulfur compound addition unit 24 based on the measured values (measurement value measured by TOC measurement unit 16) acquired from water treatment management device 18. The results are shown in Table 7. The results of Comparative Example 2 shown in Table 7 are the measurement results for the configuration shown in FIG. 14, in which a urea removal function was not provided in water treatment facility 201 and the UV 206 was a medium-pressure UV device. A urea meter was arranged in parallel with TOC measurement unit 16, and the urea concentration was measured using the urea meter. As shown in Table 7, the configuration shown in FIG. 21 obtained values measured by TOC measurement unit 204 that were less than 0.5 ppb, indicating that the process is stable. In Comparison 2, urea was not removed and TOC measurement unit 204 measured values exceeding 1 ppb.

TABLE 7

Water containing TOC ppb-C

| | TOC | TOC | |
|---|---|---|---|
| | measurement | measurement | Urea-TOC |
| | unit | unit | conversion |
| | 204 | 16 | value |
| Example 4-1 | <0.5 | 1.8 | 1.4 |
| | <0.5 | 2.6 | 2.0 |
| Comparative | 1.7 | 1.9 | 1.3 |
| Example 2 | 2.0 | 2.1 | 1.7 |

### Example 4-2

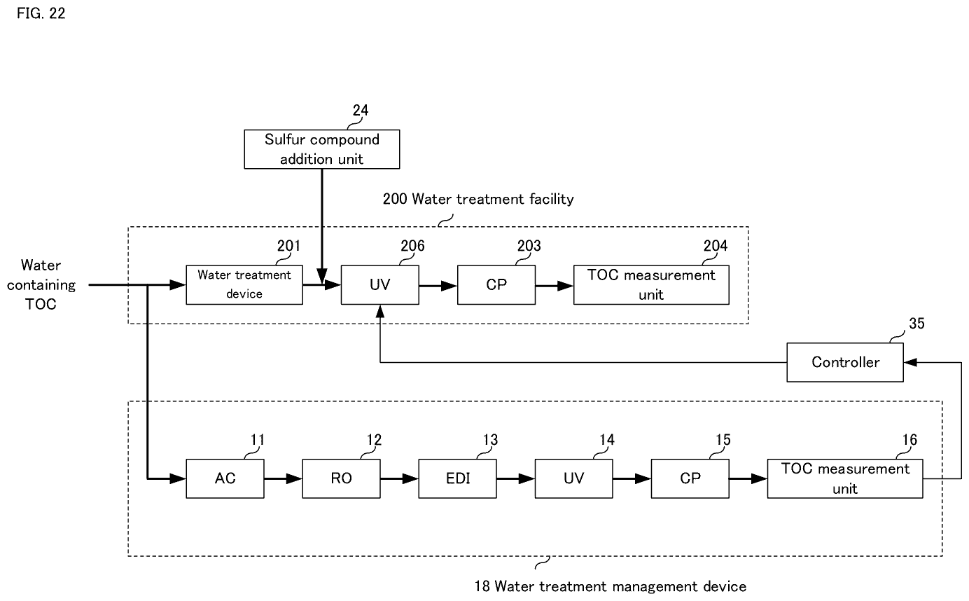

FIG. 22 is a diagram showing the configuration for Example 4-2 of the water treatment system of the present invention. As shown in FIG. 22, water treatment management device 18 was arranged in parallel with water treatment facility 200, which consisted of water treatment device 201 for pretreatment, UV irradiator (UV) 206 that was a medium-pressure UV device, and ion exchange resin filling device (CP) 203. Water containing TOC was caused to flow through for treatment. Water treatment management system 18 was the same as in the embodiments described above. TOC measurement unit 16 was arranged in the water treatment line of water treatment management device 18. In addition, sulfur compound addition unit 24 was provided to add an oxidizer to the treated water that passed through the UV 206. Sulfur compound addition unit 24 could also be included in water treatment facility 200. Water treatment device 201 did not have a urea removal function. Controller 35 set and controlled the UV irradiation dose irradiated by UV 206 based on the measured values acquired from water treatment management device 18 (measurement values measured by TOC measurement unit 16). The results are shown in Table 8. The results of Comparative Example 2 shown in Table 8 are the measurement results for the configuration shown in FIG. 14, where the urea removal function was not provided in water treatment device 201 and UV 206 was a medium-pressure UV device. A urea meter was arranged in parallel with TOC measurement unit 16, and the urea concentration was measured using the urea meter. As shown in Table 8, the configuration shown in FIG. 22 obtained values measured by TOC measurement unit 204 that were less than 0.5 ppb, indicating that the process is stable. In Comparative Example 2, urea was not removed and TOC measurement unit 204 measured values exceeding 1 ppb.

TABLE 8

Water containing TOC ppb-C

| | TOC | TOC | |
|---|---|---|---|
| | measurement | measurement | Urea-TOC |
| | unit | unit | conversion |
| | 204 | 16 | value |
| Example 4-2 | <0.5 | 1.9 | 1.4 |
| | <0.5 | 2.2 | 1.6 |
| Comparative | 1.7 | 1.9 | 1.3 |
| Example 2 | 2.0 | 2.1 | 1.7 |

While the present invention has been described with reference to the embodiments, the present invention is not limited to the above embodiments. Various changes can be made in the configuration and details of the present invention within the scope of the present invention that will be understood by those skilled in the art.

This application claims priority based on JP 2022-147932 filed Sep. 16, 2022, and incorporates herein all of the disclosures of that application.

1. A water treatment system, comprising:
a water treatment facility equipped with a plurality of water treatment devices to treat treated water;
a water treatment management device to which is supplied the treated water that is supplied to any of the plurality of water treatment devices; and
a controller that controls operating conditions of the water treatment devices, wherein
the water treatment management device comprises:
a first measurement unit that measures TOC concentration of water that is being passed through a water flow line of the water treatment management device; and
a second measurement unit that measures concentration of specific organic matter in the water that is being passed through the water flow line of the water treatment management device, wherein
the controller controls operating conditions of the water treatment devices based on the TOC concentration measured by the first measurement unit and the concentration of specific organic matter measured by the second measurement unit.

2. The water treatment system according to claim 1, comprising:
a UV irradiator as one of the water treatment devices, wherein
the controller controls an irradiation dose from the UV irradiator as an operating condition.

3. The water treatment system according to claim 2, wherein
the controller controls at least one of: a number of lamps of the UV irradiator, treatment flow rate, and lamp dimming.

4. The water treatment system according to claim 2, further comprising:
a degasser arranged preceding the UV irradiator as one of the water treatment devices, wherein
the controller controls at least one of: an irradiation dose of UV radiation and the dissolved oxygen concentration of the treated water in the UV irradiator.

5. The water treatment system according to claim 2, comprising:
an oxidizer addition means that adds an oxidizer to the treated water that is to be passed through the UV irradiator, wherein
the controller controls at least one of: the amount of oxidizer added by the oxidizer addition means and the irradiation dose from the UV irradiator based on the TOC concentration measured by the first measurement unit and the concentration of specific organic matter measured by the second measurement unit.

6. The water treatment system according to claim 5, wherein
the oxidizer is a sulfur compound containing peroxide groups.

7. The water treatment system according to claim 2, further comprising:
a low-pressure UV irradiator arranged preceding or following the UV irradiator as one of the water treatment devices.

8. The water treatment system according to claim 7, wherein
the controller controls the irradiation dose of UV radiation from the low-pressure UV irradiator based on the TOC concentration measured by the first measurement unit and the organic matter concentration measured by the second measurement unit.

9. A water treatment system, comprising:
a water treatment facility equipped with a plurality of water treatment devices to treat treated water;
a water treatment management device to which is supplied the treated water that is supplied to any of the plurality of the water treatment devices;
an oxidizer addition means that adds an oxidizer to the treated water; and
a controller that controls operating conditions of the water treatment devices, wherein
the water treatment management device comprises:
a measurement unit that measures TOC concentration of the water that is being passed through a water flow line of the water treatment management device, wherein
the controller, based on the TOC concentration measured by the measurement unit, controls at least one of the amount of oxidizer added by the oxidizer addition means and the irradiation dose applied to the treated water to which the oxidizer addition means has added oxidizer from, of the plurality of water treatment devices, the UV irradiator.

10. A water treatment method, comprising:
measuring the TOC concentration of water being passed through a water flow line of a water treatment management device to which is supplied treated water that is supplied to any of a plurality of water treatment devices in a water treatment facility that uses the plurality of water treatment devices to treat the treated water;
measuring concentration of specific organic matter in the water that is being passed through the water flow line of the water treatment management device; and
controlling operating conditions of the water treatment devices based on the measured TOC concentration and the measured concentration of the specific organic matter.
